(19) United States
(12) Patent Application Publication
(10) Pub. No.: US 2021/0127796 A1
(43) Pub. Date: May 6, 2021

(54) METHOD FOR ASSISTING JOINING OF VAMP AND SOLE BY VACUUM POSITIONING

(71) Applicant: ZHONGSHAN YOURWAY FASHION TECHNOLOGY LTD., ZHONGSHAN CITY (CN)

(72) Inventor: Chin-Hsun HSIAO, ZHONGSHAN CITY (CN)

(21) Appl. No.: 17/076,169

(22) Filed: Oct. 21, 2020

(30) Foreign Application Priority Data
Nov. 1, 2019 (TW) 108139676

(51) Int. Cl. A43D 25/047

(52) U.S. Cl. CPC A43D 25/047

(57) ABSTRACT

The invention provides a method for assisting a joining of a vamp and a sole by vacuum positioning. Initially, the method is that placing a shoe last in a vamp to be joined, coating a liquid medium to a side of the vamp to be joined with a sole or a side of the sole to be joined with the vamp, and combining the vamp with the sole. Afterward, placing the vamp and the sole in a bag, performing a vacuum operation on the bag to press the vamp and the sole, performing a microwave heating operation on the bag to heat the liquid medium to make the vamp join with the sole, and finally taking out the joined vamp and sole from the bag to obtain a finished product.

### FIELD OF THE INVENTION

The invention relates to a joining method, and more particularly to a method for assisting a joining of a vamp and a sole by vacuum positioning.

### BACKGROUND OF THE INVENTION

Nowadays, when the vamp and the sole are joined in shoe factories, they usually use the method of direct alignment and bonding after coating with an adhesive. During joining, first apply an adhesive to a sole upper edge and a vamp lower edge respectively; then the sole and the vamp are directly aligned and glued to form a shoe; after the shoe is aligned and bonded, a jig or a fixture is used to apply pressure to upper and lower sides of the shoe, and then the adhesive is cured by heating (or left alone and waited for a long period of time). However, in the conventional bonding method, the vamp and the sole are usually joined together by the staff with both hands to directly combine the vamp and the sole for alignment and bonding of the shoe. In other words, if misalignment occurs when the sole and the vamp are aligned and combined together, the vamp can no longer be separated from the sole of the shoe and the shoe must be classified as a defective product. That is, the staff must needs high proficient skills to be able to perform the alignment and bonding operation of the vamp and the sole. Furthermore, after the shoe is bonded, curing of the adhesive needs to be performed by reheating or being left alone and waited for a long period of time and applying pressure to the upper and lower sides of the shoe, so that it must needs a jig or a fixture to exert pressure on the vamp and the sole. It is commonly known that the sole that is joined with the vamp is often ergonomically designed to be curved, and because the sizes of the sole are different, and the styles and shapes are also different. Thus, the shoe factories have difficulty in designing and manufacturing jigs and fixtures. If different jigs and fixtures are produced for the sole with different sizes or styles, this will not only cause a great economic burden on the shoe factories, but also cause troublesome for the staff in choosing between different jigs and fixtures. In addition, if the adhesive is heated to be cured after the bonded shoe is exerted with pressure by a jig and a fixture, the jig and the fixture must also be made of materials that can withstand high temperatures, which will definitely increase difficulty and economic burden of shoe factories in designing and manufacturing; therefore, nowadays the shoe factories mostly use jigs and fixtures that can be universally used in the sole with various sizes and styles. However, the versatile jig and fixture can only be used for exerting pressure to specific positions of the bonded shoe, but the pressure cannot be applied uniformly in all directions. Therefore, front and rear ends of the sole of the shoe often peel off from the vamp.

### SUMMARY OF THE INVENTION

A main object of the invention is to solve the problem that the sole and the vamp cannot be separated and re-aligned and re-combined after occurrence of misalignment when the sole and the vamp are aligned and bonded together conventionally.

Another main object of the invention is to solve the problem that the jig and the fixture cannot uniformly apply pressure to the bonded shoe in all directions during the traditional bonding operation.

In order to achieve the above objects, the invention provides a method for assisting joining of a vamp and a sole by vacuum positioning, the method comprising:

step A: placing a shoe last in a vamp to be joined;

step B: coating a liquid medium to a side of the vamp to be joined with a sole or a side of the sole to be joined with the vamp, wherein the liquid medium includes a transition temperature that the liquid medium is not adhesive if a temperature of the liquid medium is lower than the transition temperature; and the liquid medium becomes adhesive if the liquid medium is heated to cause the temperature higher than the transition temperature;

step C: combining the vamp with the sole;

step D: placing the vamp and the sole in a bag;

step E: performing a vacuum operation on the bag to make the bag press the vamp and the sole and to restrict movements of the vamp and the sole;

step F: performing a microwave heating operation to the bag to heat the liquid medium and to make the vamp join with the sole; and

step G: taking out the vamp and the sole that have been joined from the bag.

In one embodiment, step E includes a sub-step: checking whether a joint position of the vamp and the sole is correct, wherein if the joint position of the vamp and the sole is correct, proceeding to next step F; and if the joint position of the vamp and the sole is not correct, releasing pressing on the vamp and the sole caused by the bag and making a re-adjustment and then repeat step E.

In one embodiment, step C further includes a sub-step: disposing an auxiliary positioning sleeve outside the sole and the vamp to restrict a relative position between the sole and the vamp, and wherein the auxiliary positioning sleeve is non-metallic and incapable of fusing and deforming upon the microwave heating operation.

In one embodiment, step G further includes a sub-step: removing the auxiliary positioning sleeve.

In one embodiment, a material of the sole is selected from the group consisting of a polyester fiber, an ethylene vinyl acetate (EVA) copolymer resin, a thermoplastic polyurethane (TPU), a polyamide elastomer and a nylon.

In one embodiment, the bag is transparent to provide direct observation of the vamp and the sole from an appearance of the bag.

In one embodiment, the liquid medium is produced by mixing a pre-mixed material with water, and the pre-mixed material is selected from a group consisting of a nylon powder, a polylactic acid (PLA) powder, a rubber powder, a thermoplastic polyurethane (TPU) powder and an ethylene vinyl acetate (EVA) copolymer resin powder.

According the foregoing invention, compared with the prior art, the invention has the following features: the invention directly puts the vamp and the sole into the bag, so that the staff can directly observe through the bag to check whether the vamp and the sole have been accurately aligned, and at the same time, and in all directions whether the vamp and the sole have misalignment of joint position. Further, if the vamp and the sole have misalignment of joint position, because the liquid medium does not become adhesive without heated, the vamp can be separated from the sole directly and re-aligning and re-combining the vamp with the sole. Furthermore, in the invention, by performing the vacuum operation on the bag, the bag is tightly attached to the vamp and the sole to press the vamp and the sole in all directions, so that the vamp and the sole can be fully pressurized and positioned before heating by microwave, and the vamp and the sole can be tightly joined. In addition, the bag or the auxiliary positioning sleeve of the invention can be used repeatedly, which not only reduces the costs and burden of the shoe factories in making different jigs and fixtures, but also solves the problem of difficulty for the staff to choose between different jigs and fixtures for the sole with different sizes or styles.

### BRIEF DESCRIPTION OF THE DRAWINGS

FIG. 1 is a flow chart according to one embodiment of the invention;

FIG. 2 is a schematic diagram of a vamp and a sole according to one embodiment of the invention;

FIG. 3 is a schematic diagram of a vamp and a sole placed in a bag according to one embodiment of the invention;

FIG. 4 is a schematic diagram of a vamp and a sole after vacuuming according to one embodiment of the invention;

FIG. 5 is another schematic diagram of a vamp and a sole after vacuuming according to one embodiment of the invention;

FIG. 6 is a schematic diagram of a joint between a vamp and a sole after microwaved according to one embodiment of the invention;

FIG. 7 is a schematic diagram of a joined vamp and sole according to one embodiment of the invention;

FIG. 8 is another flow chart according to one embodiment of the invention;

FIG. 9 is a flow chart according to another embodiment of the invention;

FIG. 10 is a schematic diagram of a vamp, a sole and an auxiliary positioning sleeve according to another embodiment of the invention;

FIG. 11 is a schematic diagram of a vamp, a sole and an auxiliary positioning sleeve placed in the bag according to another embodiment of the invention;

FIG. 12 is a schematic diagram of a vamp, a sole and an auxiliary positioning sleeve after vacuuming according to another embodiment of the invention;

FIG. 13 is another schematic diagram of the vamp, a sole and an auxiliary positioning sleeve after vacuuming according to another embodiment of the invention; and

FIG. 14 is a schematic diagram of a joint between a vamp and a sole after microwaved according to another embodiment of the invention.

### DETAILED DESCRIPTION OF THE PREFERRED EMBODIMENTS

The detailed description and technical content of the invention are described below with reference to the drawings.

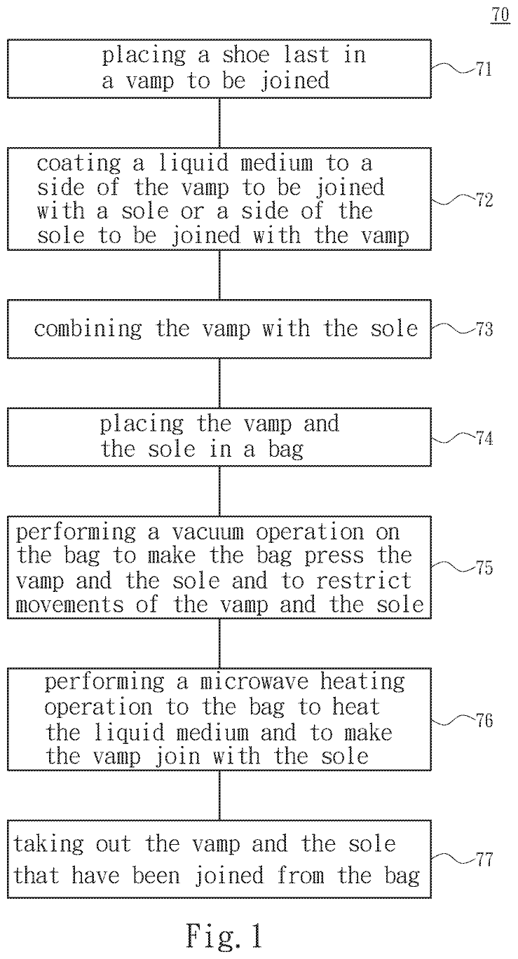

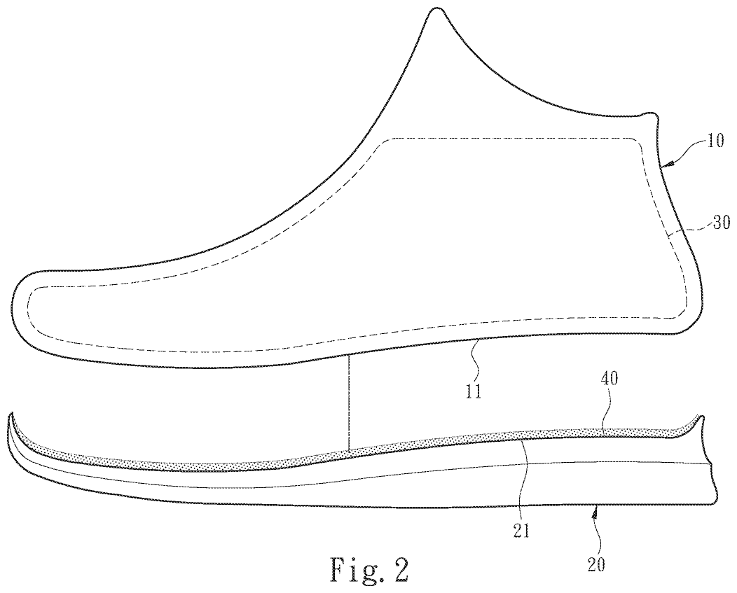

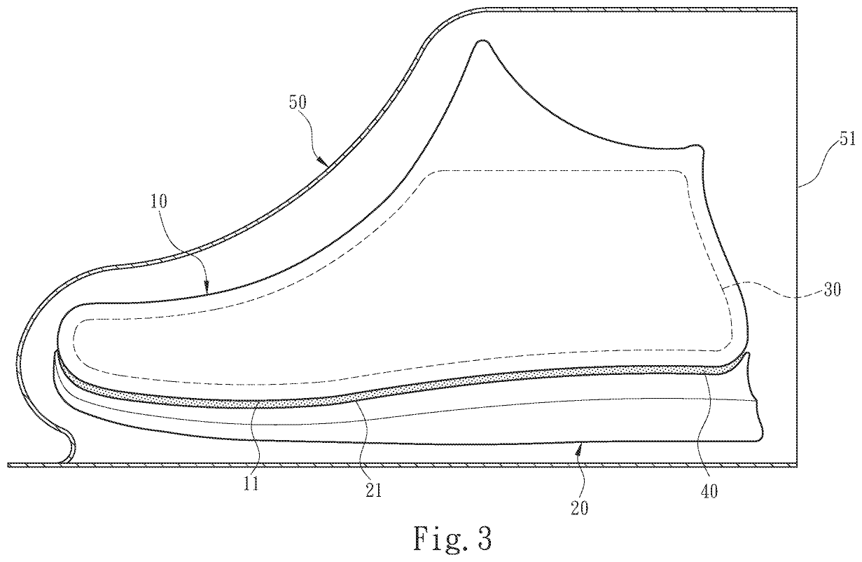

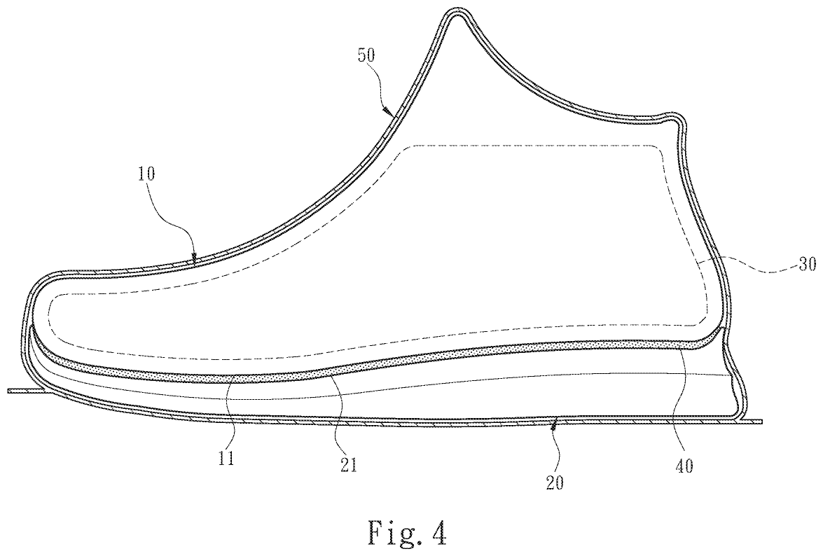

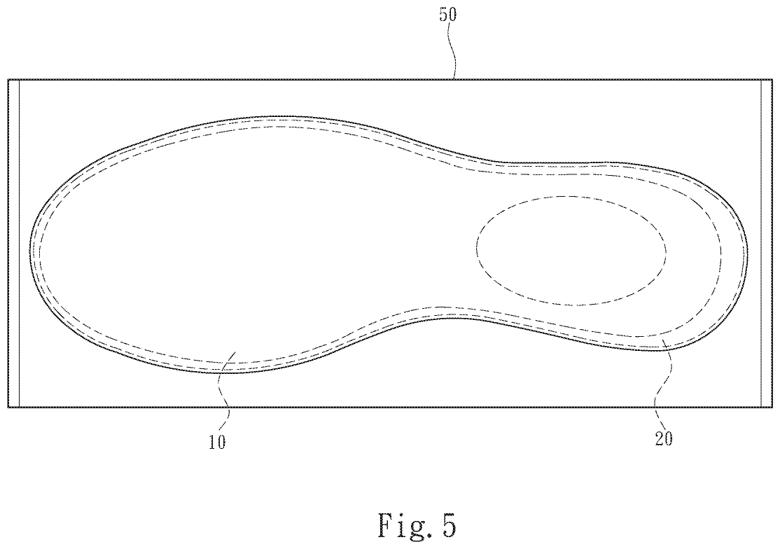

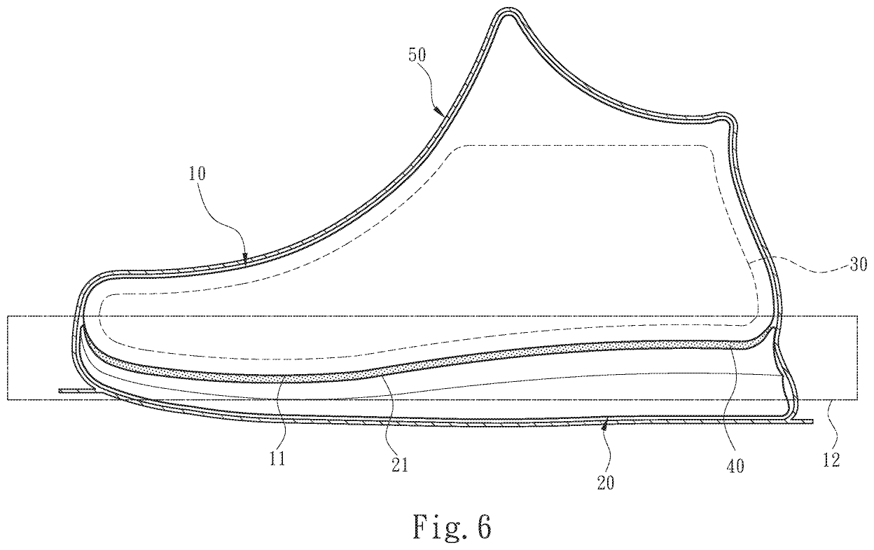

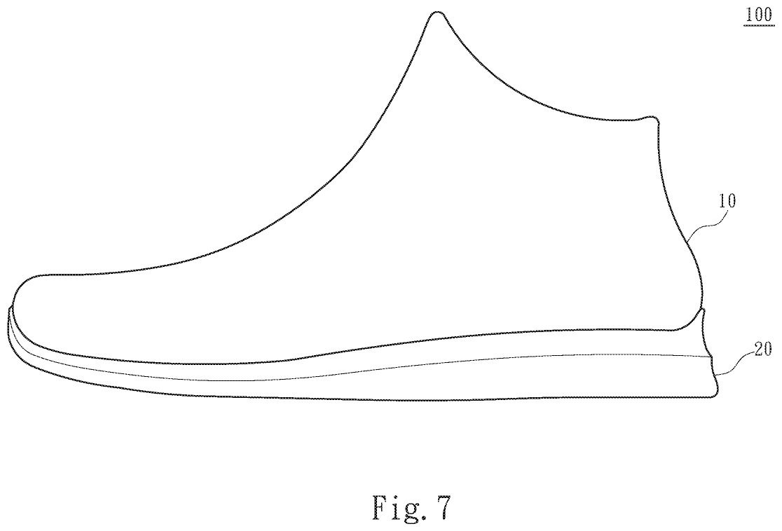

Please refer to FIG. 1, FIG. 2, FIG. 3, FIG. 4, FIG. 5, FIG. 6 and FIG. 7. The invention provides a method 70 for assisting a joining of a vamp and a sole by vacuum positioning, the method 70 comprising:

step A 71: placing a shoe last 30 in a vamp 10 to be joined;

step B 72: coating a liquid medium 40 to a side 11 of the vamp 10 to be joined with a sole 20 or a side 21 of the sole 20 to be joined with the vamp 10, wherein the liquid medium 40 includes a transition temperature that the liquid medium 40 is not adhesive if a temperature of the liquid medium 40 is lower than the transition temperature; and the liquid medium 40 becomes adhesive if the liquid medium 40 is heated to cause the temperature higher than the transition temperature;

step C 73: combining the vamp 10 with the sole 20;

step D 74: placing the vamp 10 and the sole 20 in a bag 50;

step E 75: performing a vacuum operation on the bag 50 to make the bag 50 press the vamp 10 and the sole 20 and to restrict movements of the vamp 10 and the sole 20;

step F 76: performing a microwave heating operation to the bag 50 to heat the liquid medium 40 and to make the vamp 10 join with the sole 20; and

step G 77: taking out the vamp 10 and the sole 20 that have been joined from the bag 50.

On the one hand, before describing the detailed implementation steps of the method 70, the vamp 10, the sole 20, the shoe last 30, the liquid medium 40 and the bag 50 are described first. The vamp 10 of the invention is made by using the current vamp knitting method for a person having ordinary skill in the art. That is, the vamp 10 can be formed by splicing a plurality of cloth materials, or in an integral cloth. Besides, a material of the sole 20 is selected from the group consisting of a polyester fiber, an ethylene vinyl acetate (EVA) copolymer resin, a thermoplastic polyurethane (TPU), a polyamide elastomer and a nylon (Nylon), and the sole 20 can be made by using the current sole manufacturing method for a person having ordinary skill in the art. In addition, since the knitting method of the vamp 10 and the manufacturing method of the sole 20 are not the focus of application in the invention, the detailed description is omitted here.

On the other hand, the shoe last 30 is used to define a shape and a form of the vamp 10. In actual implementation, the method 70 can cause a shape of a shoe made by the vamp 10 different by using the different shoe lasts 30. Further, the liquid medium 40 is used to bond the vamp 10 with the sole 20. In one embodiment, the liquid medium 40 is produced by mixing a pre-mixed material with water. The pre-mixed material can be a nylon powder, a polylactic acid (PLA) powder, a rubber powder, a thermoplastic polyurethane (TPU) powder, or an ethylene vinyl acetate (EVA) copolymer resin powder. Further, the liquid medium 40 includes a transition temperature higher than room temperature. Namely, if a temperature of the liquid medium 40 is lower than the transition temperature, the liquid medium 40 is not adhesive; on the contrary, the liquid medium 40 undergoes a chemical reaction and becomes adhesive. In addition, a material of the bag 50 is a polypropylene (PP), the bag 50 is transparent or translucent, and a tensile strength of the bag 50 is high, so that the bag 50 does not break during the vacuum operation. Further, in an example, a tensile strength of the bag 50 is greater than 54 Kgf/m². In addition, the bag 50, the vamp 10, and the sole 20 of the invention do not fuse together due to heat during implementation of the method 70; for example, a glass transition temperature of the bag 50, a glass transition temperature of the vamp 10, and a glass transition temperature of the sole 20 are greater than 180° C. and higher than the transition temperature of the liquid medium 40, so that when the liquid medium 40 is heated to become adhesive, the bag 50 does not deform as the liquid medium 40 fuses.

Then, the method 70 is described as follows. At the beginning of implementation, the shoe last 30 is placed in the vamp 10 in step A 71; and in step B 72, the liquid medium 40 is coated to the side 11 of the vamp 10 to be joined with the sole 20 or the side 21 of the sole 20 to be joined with the vamp 10. Accordingly, since an ambient temperature of the liquid medium 40 is lower than the transition temperature and the liquid medium 40 is not heated, the liquid medium 40 is not adhesive. Then, proceeding to step C 73 and step D 74, the vamp 10 is combined with the sole 20 where the vamp 10 is located above the sole 20, and then the vamp 10 and the sole 20 are inserted into the bag 50 through an opening 51 of the bag 50 to be ready for performing the vacuum operation and the microwave heating operation. In one embodiment, the bag 50 is transparent to provide direct observation of the vamp 10 and the sole 20 from the appearance of the bag 50 to confirm whether the vamp 10 and the sole 20 have been accurately aligned without any misalignment before the vacuum operation or after the vacuum operation is complete. If a joint position of the vamp 10 and the sole 20 is misaligned, since the liquid medium 40 does not become adhesive if not heated, the vamp 10 can be separated from the sole 20 directly and re-aligning and re-combining the vamp 10 with the sole 20.

Proceeding to step E 75 and step F 76, the vacuum operation is performed on the bag 50 to make the bag 50 press the vamp 10 and the sole 20 therein. Also, since the tensile strength of the bag 50 is high, the bag 50 does not break. After the bag 50 completes the vacuum operation, the bag 50 enables the vamp 10 and the sole 20 to be completely positioned and tightly attached with each other, and then the microwave heating operation is performed on the bag 50. Specifically, a work time of the microwave heating operation is 30 seconds, and a working temperature of the microwave heating is greater than the transition temperature of the liquid medium 40. Thus, after the microwave heating operation is performed on the bag 50, the liquid medium 40 is heated to become adhesive to join the vamp 10 with the sole 20. In one embodiment, the heating principle of a microwave oven is that the electromagnetic field of an electromagnetic wave causes water molecules to vibrate repeatedly and then collide with other water molecules to generate heat energy, and the liquid medium 40 of the invention is produced by mixing the pre-mixed material with water. Namely, the microwave heating operation only generates a heating reaction at a joint 12 coated with the liquid medium 40 between the vamp 10 and the sole 20. That is, except at the joint 12, there are no water molecules at other positions. Thus, the microwave heating operation can be described as a target microwave operation. Finally, in step G 77, after the microwave heating operation is complete and the joint 12 between the vamp 10 and the sole 20 is cooled, the vamp 10 and the sole 20, that have been accurately aligned and tightly joined together, are taken out from the bag 50 to obtain a finished product 100.

Besides, the method 70 of the invention directly places the vamp 10 and the sole 20 into the bag 50 and vacuums the bag 50, so that the bag 50 provides direct observation of the vamp 10 and the sole 20 from the appearance of the bag 50. Thereby, the staff can check in all directions whether a joint position of the vamp 10 and the sole 20 has been accurately aligned without any misalignment. Furthermore, through the vacuum operation performing on the bag 50, the bag 50 is tightly attached to the vamp 10 and the sole 20 to press the vamp 10 and the sole 20 in all directions, and the vamp 10 and the sole 20 are pressurized and positioned in all directions before performing the microwave heating operation. Therefore, the vamp 10 and the sole 20 to be joined will not have misalignment, and the side 11 of the vamp 10 and the side 21 of the sole 20 to be bonded to each other can obtain a more uniform pressure to produce a complete contact, so that after the vamp 10 and the sole 20 are joined by microwave heating operation, there will be no local peeling problem. Compared with the conventional technique, the method 70 of the invention directly pressurizes and positions the vamp 10 and the sole 20 in all directions through the vacuum operation performed on the bag 50, which is reusable, thereby reducing the use of jigs and fixtures.

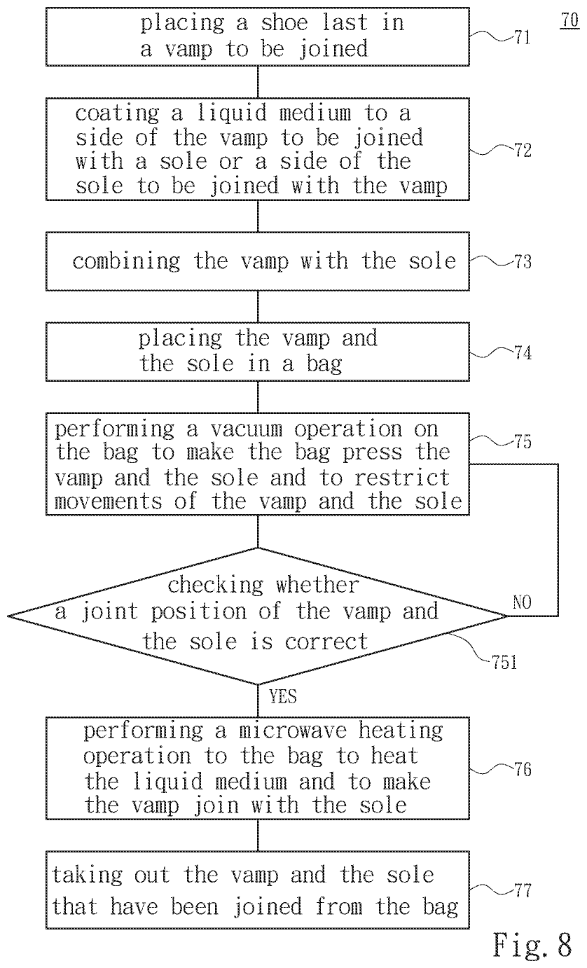

Furthermore, please refer to FIG. 4, FIG. 5 and FIG. 8 for one embodiment. After the bag 50 is performed with the vacuum operation, the step E 75 further includes a sub-step 751: checking whether a joint position of the vamp 10 and the sole 20 is correct. If the joint position of the vamp 10 and the sole 20 is correct, proceeding to the step F 76 of directly performing the microwave heating operation. If the joint position of the vamp 10 and the sole 20 is misaligned, a vacuum state of the bag 50 is released so that the bag 50 no longer presses the vamp 10 and the sole 20, and then re-adjust relative positions of the vamp 10 and the sole 20, and the step E 75 is performed again to perform the vacuuming operation on the bag 50.

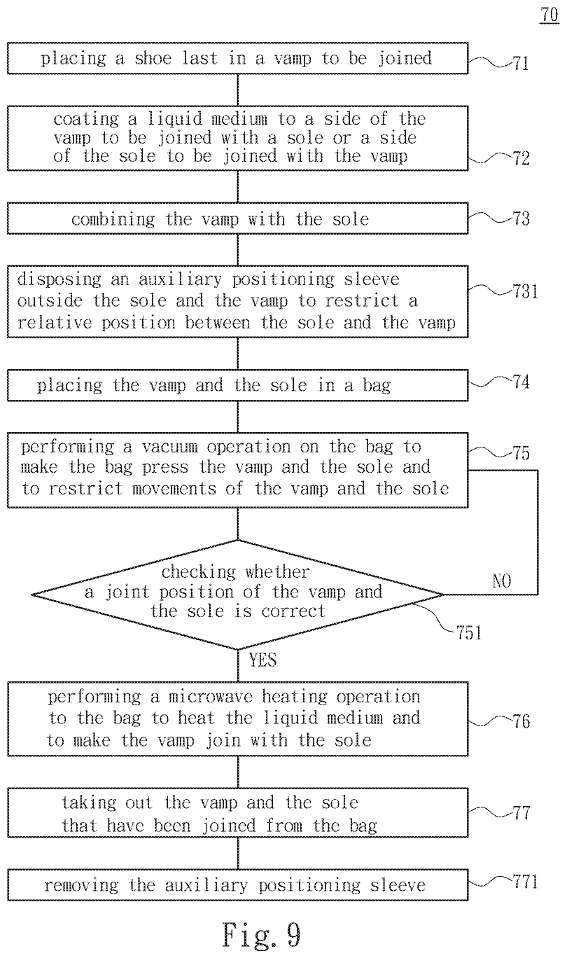

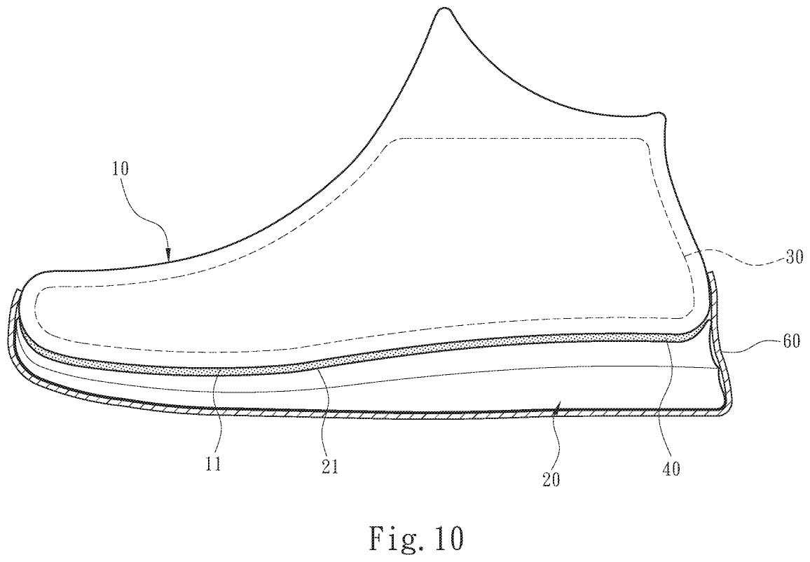

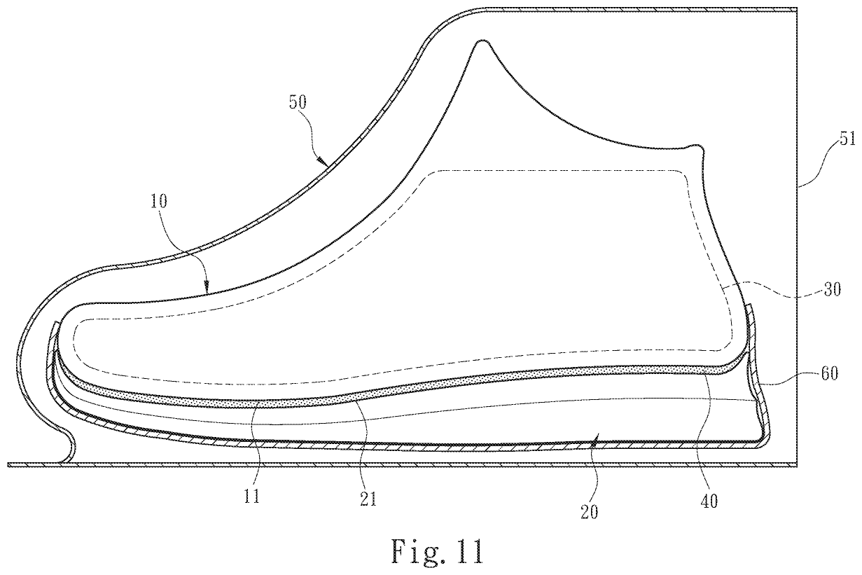

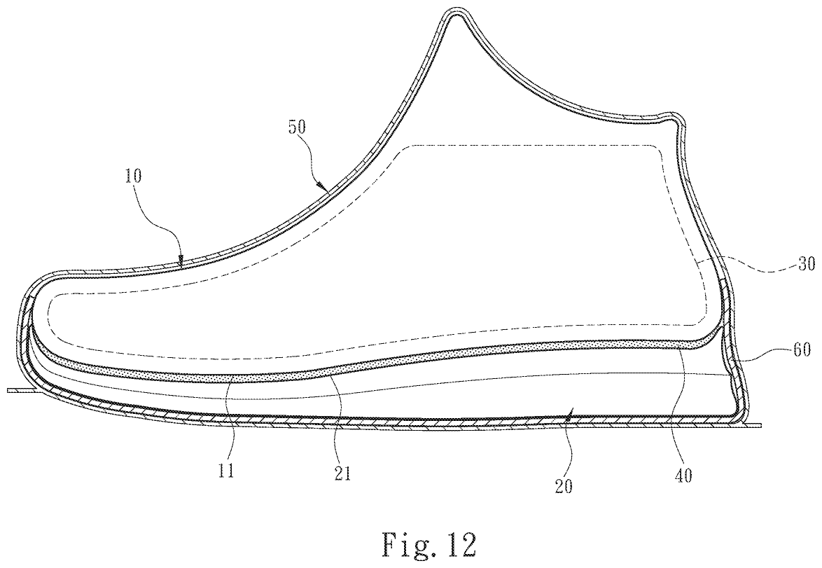

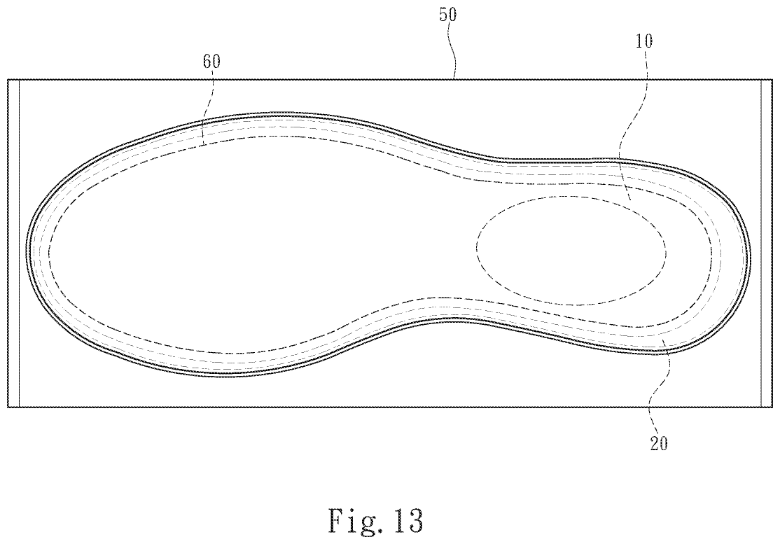

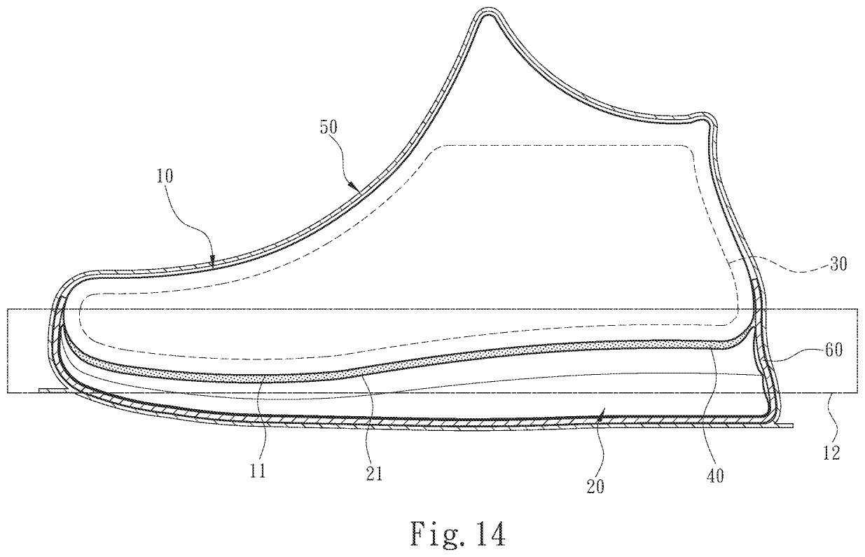

Please refer to FIG. 7, FIG. 9, FIG. 10, FIG. 11, FIG. 12, FIG. 13 and FIG. 14. In order to strengthen a restriction between the vamp 10 and the sole 20 before the vacuum operation, the method 70 further includes an auxiliary positioning sleeve 60 to position the vamp 10 and the sole 20 preliminarily. Furthermore, before describing an implementation method of the auxiliary positioning sleeve 60, it needs to mention that the auxiliary positioning sleeve 60 is not made of metal, and a glass transition temperature of the auxiliary positioning sleeve 60 is greater than the transition temperature of the liquid medium 40, so that the auxiliary positioning sleeve 60 does not fuse and deform when the liquid medium 40 is heated to become adhesive. Then, implementation of the auxiliary positioning sleeve 60 will be described as follows. Step C 73 of the method 70 further includes a sub-step 731: disposing the auxiliary positioning sleeve 60 outside the sole 20 and the vamp 10. In more detail, after the vamp 10 and the sole 20 are combined, the auxiliary positioning sleeve 60 is at least covers one side of the vamp 10 and the sole 20, and then the vamp 10 and the sole 20 are placed into the bag 50. Proceeding to step E 75, perform the vacuum operation on the bag 50. Since the auxiliary positioning sleeve 60 is disposed outside the sole 20 and vamp 10, and the auxiliary positioning sleeve 60 restricts a relative position between the sole 20 and the vamp 10 preliminarily. So after the bag 50 is vacuumed, the bag 50 can simultaneously press the auxiliary positioning sleeve 60, the vamp 10 and the sole 20 with positions restricted by the auxiliary positioning sleeve 60, thereby the vamp 10 and the sole 20 are pressurized and positioned more tightly in all directions. Afterward, the microwave heating operation is performed on the bag 50 to make the liquid medium 40 join the vamp 10 with the sole 20. After the vamp 10 and the sole 20 are joined and cooled, the bag 50 is released from a vacuum state, and the vamp 10 and the sole 20 that have been accurately aligned and tightly joined are taken out from the bag 50. Finally, performing a sub-step 771 of the step G 77, it removes the auxiliary positioning sleeve 60 to obtain the finished product 100.

Furthermore, after placing the vamp 10, the sole 20 and the auxiliary positioning sleeve 60 in the bag 50 and performing the vacuum operation, if a joint position of the vamp 10 and the sole 20 is misaligned, a vacuum state of the bag 50 is released. Since the liquid medium 40 does not becomes adhesive, the vamp 10 can be separated from the sole 20 directly and a joint position between the vamp 10 and the sole 20 can be re-adjusted. If necessary, re-adjusting the auxiliary positioning sleeve 60 to make a joint position of the vamp 10 and the sole 20 more accurate.

What is claimed is:

1. A method for assisting a joining of a vamp and a sole by vacuum positioning comprising:
step A: placing a shoe last in a vamp to be joined;
step B: coating a liquid medium to a side of the vamp to be joined with a sole or a side of the sole to be joined with the vamp, wherein the liquid medium includes a transition temperature that the liquid medium is not adhesive if a temperature of the liquid medium is lower than the transition temperature; and the liquid medium becomes adhesive if the liquid medium is heated to cause the temperature higher than the transition temperature;
step C: combining the vamp with the sole;
step D: placing the vamp and the sole in a bag;
step E: performing a vacuum operation on the bag to make the bag press the vamp and the sole and to restrict movements of the vamp and the sole;
step F: performing a microwave heating operation to the bag to heat the liquid medium and to make the vamp join with the sole; and
step G: taking out the vamp and the sole that have been joined from the bag.

2. The method for assisting the joining of the vamp and the sole by vacuum positioning as claimed in claim 1, wherein step E includes a sub-step: checking whether a joint position of the vamp and the sole is correct, wherein if the joint position of the vamp and the sole is correct, proceeding to next step F; and if the joint position of the vamp and the sole is not correct, releasing pressing on the vamp and the sole caused by the bag and making a re-adjustment and then repeat step E.

3. The method for assisting the joining of the vamp and the sole by vacuum positioning as claimed in claim 1, wherein step C further includes a sub-step: disposing an auxiliary positioning sleeve outside the sole and the vamp to restrict a relative position between the sole and the vamp, and wherein the auxiliary positioning sleeve is non-metallic and incapable of fusing and deforming upon the microwave heating operation.

4. The method for assisting the joining of the vamp and the sole by vacuum positioning as claimed in claim 3, wherein step G further includes a sub-step: removing the auxiliary positioning sleeve.

5. The method for assisting the joining of the vamp and the sole by vacuum positioning as claimed in claim 3, wherein a material of the sole is selected from the group consisting of a polyester fiber, an ethylene vinyl acetate (EVA) copolymer resin, a thermoplastic polyurethane (TPU), a polyamide elastomer and a nylon.

6. The method for assisting the joining of the vamp and the sole by vacuum positioning as claimed in claim 1, wherein the bag is transparent to provide direct observation of the vamp and the sole from an appearance of the bag.

7. The method for assisting the joining of the vamp and the sole by vacuum positioning as claimed in claim 6, wherein the liquid medium is produced by mixing a pre-mixed material with water, and the pre-mixed material is selected from a group consisting of a nylon powder, a polylactic acid (PLA) powder, a rubber powder, a thermoplastic polyurethane (TPU) powder and an ethylene vinyl acetate (EVA) copolymer resin powder.

8. The method for assisting the joining of the vamp and the sole by vacuum positioning as claimed in claim 7, wherein a material of the sole is selected from the group consisting of a polyester fiber, an ethylene vinyl acetate (EVA) copolymer resin, a thermoplastic polyurethane (TPU), a polyamide elastomer and a nylon.

9. The method for assisting the joining of the vamp and the sole by vacuum positioning as claimed in claim 1, wherein the liquid medium is produced by mixing a pre-mixed material with water, and the pre-mixed material is selected from a group consisting of a nylon powder, a polylactic acid (PLA) powder, a rubber powder, a thermoplastic polyurethane (TPU) powder and an ethylene vinyl acetate (EVA) copolymer resin powder.

10. The method for assisting the joining of the vamp and the sole by vacuum positioning as claimed in claim 1, wherein a material of the sole is selected from the group consisting of a polyester fiber, an ethylene vinyl acetate (EVA) copolymer resin, a thermoplastic polyurethane (TPU), a polyamide elastomer and a nylon.
